(19) United States
(12) Patent Application Publication
(10) Pub. No.: US 2014/0146059 A1
(43) Pub. Date: May 29, 2014

(54) COMPUTING DEVICE AND METHOD FOR CONTROLLING DVI CONNECTION BETWEEN VGA CARD AND DISPLAY DEVICE

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/037,405

(22) Filed: Sep. 26, 2013

(30) Foreign Application Priority Data
Nov. 27, 2012 (TW) 101144285

(51) Int. Cl. G09G 5/00

(52) U.S. Cl. CPC G09G 5/006
USPC 345/520

(57) ABSTRACT

In a method for controlling a digital visual interface (DVI) connection between a video graphics array (VGA) card and a display device of a computing device, the VGA card includes a graphics processing unit, and a DVI connector connected to the signal switch through two DVI links. When a DVI resolution of the VGA card is greater than a display resolution of the display device, the method controls the graphics processing unit to turn on both of the two DVI links and controlling the signal switch to invoke a dual-link DVI mode of the VGA card. When the DVI resolution is not greater than the display resolution the method controls the graphics processing unit to shut off one of the two DVI links, and controls the signal switch to change the dual-link DVI mode of the VGA card to a single link DVI mode of the VGA card.

### BACKGROUND

1. Technical Field

Embodiments of the present disclosure relate to display control systems and methods, and particularly to a computing device and method for controlling a digital visual interface (DVI) connection between a video graphics array (VGA) card and a display device of the computing device.

2. Description of Related Art

Digital visual interface (DVI) specification defines two types of DVI links for transmitting digital video data from a computer to a display device. The display device connects to a video graphics array (VGA) card installed in a motherboard of the computer. The VGA card may run under two types of DVI modes which include a single-link DVI mode and a dual-link DVI mode. When the VGA card runs in the dual-link DVI mode, the DVI resolution of the VGA card may be 2048*1536. When the VGA card runs in the single-link DVI mode, the DVI resolution of the VGA card may be 1920*1200. However, it is a problem to control a working mode of the VGA card to change between the two different DVI modes. Therefore, there is room for improvement in the art.

### BRIEF DESCRIPTION OF THE DRAWINGS

FIG. 1 is a block diagram of one embodiment of a computing device including a DVI connection control system.

FIG. 2 is a flowchart of a first embodiment of a method for controlling a DVI connection between a VGA card and a display device of the computing device.

FIG. 3 is a flowchart of a second embodiment of a method for controlling a DVI connection between the VGA card and the display device.

FIG. 4 is a flowchart of a third embodiment of a method for controlling a DVI connection between the VGA card and the display device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

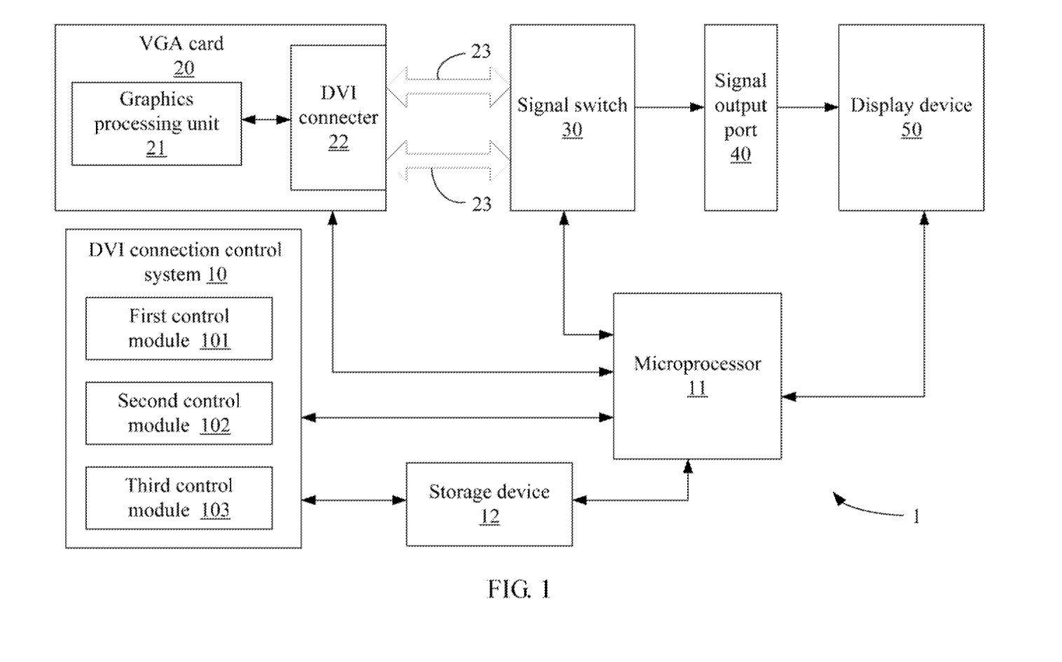

FIG. 1 is a block diagram of one embodiment of a computing device 1 including a digital visual interface (DVI) connection control system 10. In the embodiment, the computing device 1 may further include, but is not limited to, a microprocessor 11, a storage device 12, a video graphics array (VGA) card 20, a signal switch 30, a signal output port 40, and a display device 50. The VGA card 20 connects to the signal switch 30, the signal switch 30 connects to the signal output port 40, and the signal output port 40 connects to the display device 50. The microprocessor 11 connects to the VGA card 20, the signal switch 30, and the display device 50. FIG. 1 is only one example of the computing device 1, other examples may include more or fewer components than those shown in the embodiment, or have a different configuration of the various components.

The VGA card 20 may include a graphics processing unit 21, and a DVI connector 22. The DVI connector 22 connects to the signal switch 30 through two DVI links 23. Each of the DVI links 23 includes a cable line that transfer video signals from the VGA card 20, and a clock signal line that controls frequency of the video signals. The graphics processing unit 21 controls the VGA card 20 to work in a single-link DVI mode or a dual-link DVI mode by invoking one or both of the two DVI links 23. If one of the DVI links 23 is invoked by the graphics processing unit 21, the VGA card 20 runs in the single-link DVI mode. If both of the two DVI links 23 are invoked by the graphics processing unit 21, the VGA card 20 runs in the dual-link DVI mode.

The signal switch 30 connects to the display device 50 through the signal output port 40. In the embodiment, the signal switch 30 controls the VGA card 20 to work in the single-link DVI mode or the dual-link DVI mode according to a display resolution or a display mode of the display device 50, and outputs DVI signals from the VGA card to the display device 50 through the signal output port 40.

In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, or a data storage medium. The at least one microprocessor 11 is a central processing unit (CPU) or data processor that performs various functions of the computing device 1.

In one embodiment, the DVI connection control system 10 may include a first control module 101, a second control module 102, and a third control module 103. The modules 101-103 may comprise computerized instructions in the form of one or more computer-readable programs that are stored in a non-transitory computer-readable medium (such as the storage device 12) and executed by the at least one microprocessor 11. A description of each module is given in the following paragraphs.

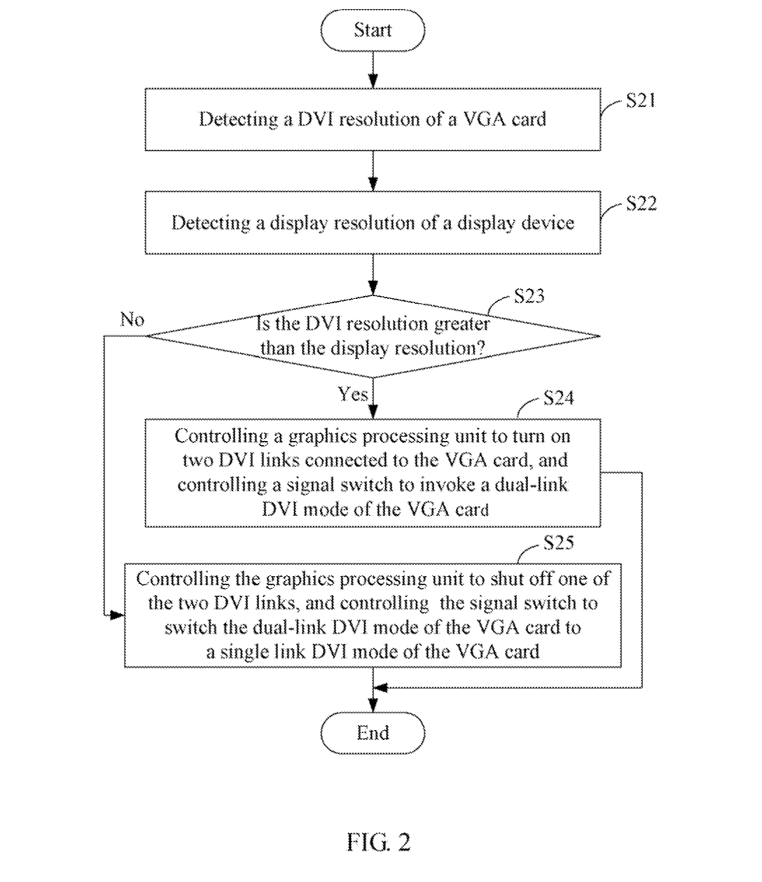

FIG. 2 is a flowchart of a first embodiment of a method for controlling a DVI connection between the VGA card 20 and the display device 50 of the computing device 1. In the first embodiment, the method can dynamically control the VGA card 20 to work in a single-link DVI mode or a dual-link DVI mode according to a display resolution of the display device 50. Depending on the embodiment, additional steps may be added, others removed, and the ordering of the steps may be changed.

In step S21, the first control module 101 detects a DVI resolution of the VGA card 40. In the embodiment, the DVI resolution of the VGA card 40 may be 3840*2400 when the VGA card 40 runs in the dual-link DVI mode, and the DVI resolution of the VGA card 40 may be 1920*1200 when the VGA card 40 runs in the single-link DVI mode.

In step S22, the first control module 101 detects a display resolution of the display device 50. In the embodiment, the display resolution of the display device 50 may be 1024*768 or 2048*1536.

In step S23, the first control module 101 determines whether the DVI resolution of the VGA card 40 is greater than the display resolution of the display device 50. If the DVI resolution of the VGA card 40 is greater than the display resolution of the display device 50, step S24 is implemented. If the DVI resolution of the VGA card 40 is not greater than the display resolution of the display device 50, step S25 is implemented.

In step S24, the first control module 101 controls the graphics processing unit 21 to turn on the two DVI links 23 connected to the VGA card 20, and controls the signal switch 30 to invoke the dual-link DVI mode of the VGA card 20. In this embodiment, if the display resolution of the display device 50 is 2048*1536, which is greater than the DVI resolution (e.g., 1920*1200) of the VGA card 40 when the VGA card 40 runs in the single-link DVI mode, then the first control module 101 control the VGA card 40 to run in the dual-link DVI mode that has a higher DVI resolution, such as 2048*1536.

In step S25, the first control module 101 controls the graphics processing unit 21 to shut off one of the two DVI links 23, and controls the signal switch 30 to change the dual-link DVI mode of the VGA card 20 to the single link DVI mode of the VGA card 20.

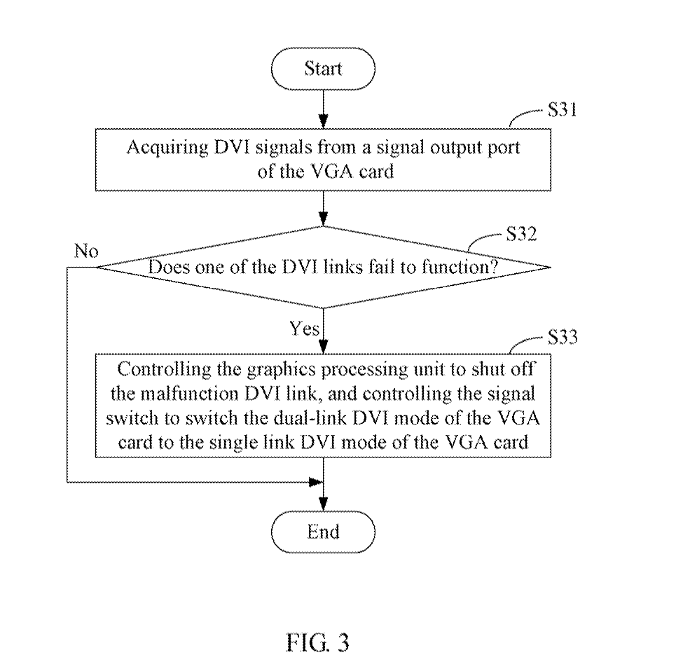

FIG. 3 is a flowchart of a second embodiment of a method for controlling a DVI connection between the VGA card 20 and the display device 50 of the computing device 1. In the second embodiment, the method can switch the DVI connection from one of the two DVI links 23 to the other DVI link 23 when one of the two DVI links 23 fails to function, to assure the VGA card 20 runs normally. Depending on the embodiment, additional steps may be added, others removed, and the ordering of the steps may be changed.

In step S31, the second control module 102 acquires DVI signals from the signal output port 40 of the VGA card 20. In the embodiment, the VGA card 20 outputs the DVI signals from the DVI connector 22, and transfers the DVI signals to the signal output port 40 through one or both of the two DVI links 23.

In step S32, the second control module 102 determines whether one of the DVI links 23 fails to function. If one of the DVI links 23 fails to function, step S33 is implemented. Otherwise, if no DVI link 23 fails to function, the process goes to end.

In step S33, the second control module 102 controls the graphics processing unit 21 to shut off the malfunction DVI link, and controls the signal switch 30 to change the dual-link DVI mode of the VGA card 20 to the single link DVI mode of the VGA card 20. In the embodiment, the second control module 102 may adjust the display resolution of the display device 50 to be 1024*768, which is less than the DVI resolution (e.g., 1920*1200) of the VGA card 40 when the VGA card 40 runs in the single-link DVI mode.

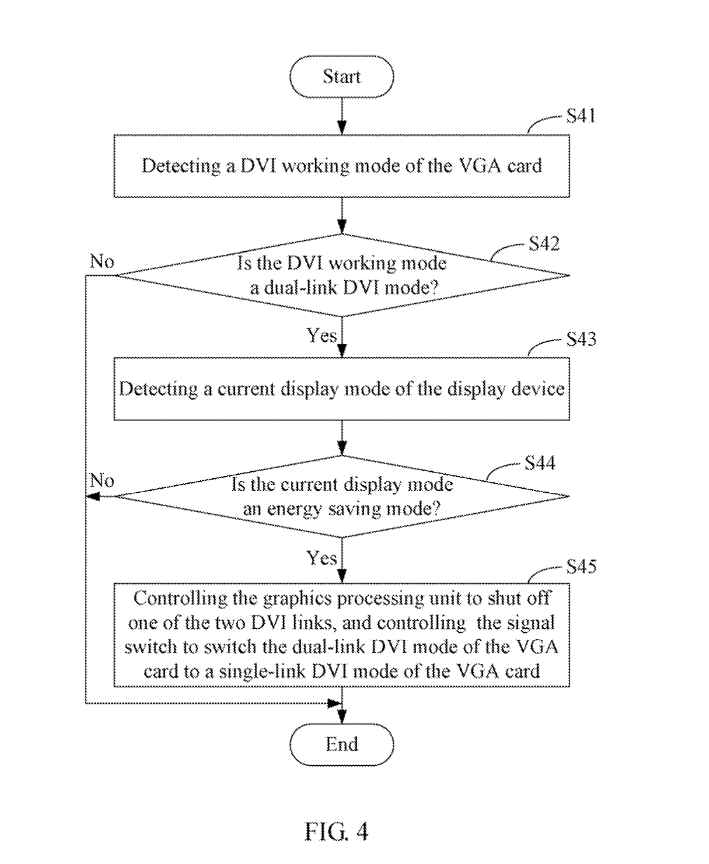

FIG. 4 is a flowchart of a third embodiment of a method for controlling a DVI connection between the VGA card 20 and the display device 50 of the computing device 1. In the third embodiment, the method can dynamically control the VGA card 20 to work in a single-link DVI mode or a dual-link DVI mode according to a display mode of the display device 50. Depending on the embodiment, additional steps may be added, others removed, and the ordering of the steps may be changed.

In step S41, the third control module 103 detects a DVI working mode of the VGA card 20. In the embodiment, the DVI working mode of the VGA card 20 may be the single-link DVI mode or the dual-link DVI mode.

In step S42, the third control module 103 determines whether the DVI working mode of the VGA card 20 is the dual-link DVI mode or the single-link DVI mode. If the DVI working mode of the VGA card 20 is the dual-link DVI mode, step S43 is implemented. Otherwise, if the DVI working mode of the VGA card 20 is the single-link DVI mode, the process ends.

In step S43, the third control module 103 detects a current display mode of the display device 50. In the embodiment, the display mode of the display device 50 may be a normal display mode for displaying videos on the display device 50 normally, or an energy saving mode for saving the energy power of the display device 50.

In step S44, the third control module 103 determines whether the current display mode of the display device 50 is the energy saving mode. If the current display mode of the display device 50 is the energy saving mode, step S45 is implemented. Otherwise, if the current display mode of the display device 50 is not the energy saving mode, the process ends.

In step S45, the third control module 103 controls the graphics processing unit 21 to shut off one of the two DVI links 23, and controls the signal switch 30 to change the dual-link DVI mode of the VGA card 20 to the single link DVI mode of the VGA card 20, to save energy that would have been used by the display device 50.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a signal switch, a display device, and at least one microprocessor;
a video graphics array (VGA) card comprising a graphics processing unit, and a digital visual interface (DVI) connector connected to the signal switch through two DVI links; and
a storage system storing a computer-readable program including instructions that, which when executed by the at least one microprocessor, causes the at least one microprocessor to:
detect a DVI resolution of the VGA card and a display resolution of the display device;
determine whether the DVI resolution of the VGA card is greater than the display resolution of the display device;
control the graphics processing unit to turn on both of the two DVI links and control the signal switch to invoke a dual-link DVI mode of the VGA card, when the DVI resolution of the VGA card is greater than the display resolution of the display device; and
control the graphics processing unit to shut off one of the two DVI links and control the signal switch to change the dual-link DVI mode of the VGA card to a single link DVI mode of the VGA card, when the DVI resolution of the VGA card is not greater than the display resolution of the display device.

2. The computing device according to claim 1, wherein the computer-readable program further causes at least one microprocessor to:
acquire DVI signals from a signal output port of the VGA card;
determine whether one of the DVI links fails to function; and
control the graphics processing unit to shut off the malfunction DVI link and control the signal switch to change the dual-link DVI mode of the VGA card to the single link DVI mode of the VGA card, when one of the DVI links fails to function.

3. The computing device according to claim 1, wherein the computer-readable program further causes at least one microprocessor to:
detect a DVI working mode of the VGA card;
determine whether the DVI working mode of the VGA card is the dual-link DVI mode;
detect a current display mode of the display device if the DVI working mode of the VGA card is the dual-link DVI mode;
determine whether the current display mode of the display device is an energy saving mode; and
control the graphics processing unit to shut off one of the two DVI links and control the signal switch to change the dual-link DVI mode of the VGA card to the single link DVI mode of the VGA card, when the current display mode of the display device is the energy saving mode.

4. The computing device according to claim 1, wherein each of the DVI links comprises a data cable line that transfers video signals from the VGA card, and a clock signal line that controls frequency of the video signals.

5. The computing device according to claim 1, wherein the VGA card runs in the single-link DVI mode when one of the DVI links is invoked by the graphics processing unit.

6. The computing device according to claim 1, wherein the VGA card runs in the dual-link DVI mode when both of the two DVI links are invoked by the graphics processing unit.

7. A method for controlling a digital visual interface (DVI) connection between a video graphics array (VGA) card and a display device of a computing device, the method comprising:
detecting a DVI resolution of the VGA card and a display resolution of the display device, the VGA card comprising a graphics processing unit, and a DVI connector connected to a signal switch through two DVI links;
determining whether the DVI resolution of the VGA card is greater than the display resolution of the display device;
controlling the graphics processing unit to turn on both of the two DVI links and controlling the signal switch to invoke a dual-link DVI mode of the VGA card, when the DVI resolution of the VGA card is greater than the display resolution of the display device; and
controlling the graphics processing unit to shut off one of the two DVI links and controlling the signal switch to change the dual-link DVI mode of the VGA card to a single link DVI mode of the VGA card, when the DVI resolution of the VGA card is not greater than the display resolution of the display device.

8. The method according to claim 7, further comprising:
acquiring DVI signals from a signal output port of the VGA card;
determining whether one of the DVI links fails to function; and
controlling the graphics processing unit to shut off the malfunction DVI link and controlling the signal switch to change the dual-link DVI mode of the VGA card to the single link DVI mode of the VGA card, when one of the DVI links fails to function.

9. The method according to claim 7, further comprising:
detecting a DVI working mode of the VGA card;
determining whether the DVI working mode of the VGA card is the dual-link DVI mode;
detecting a current display mode of the display device when the DVI working mode of the VGA card is the dual-link DVI mode;
determining whether the current display mode of the display device is an energy saving mode; and
controlling the graphics processing unit to shut off one of the two DVI links and controlling the signal switch to change the dual-link DVI mode of the VGA card to the single link DVI mode of the VGA card, when the current display mode of the display device is the energy saving mode.

10. The method according to claim 7, wherein each of the DVI links comprises a data cable line that transfers video signals from the VGA card, and a clock signal line that controls frequency of the video signals.

11. The method according to claim 7, wherein the VGA card runs in the single-link DVI mode when one of the DVI links is invoked by the graphics processing unit.

12. The method according to claim 7, wherein the VGA card runs in the dual-link DVI mode when both of the two DVI links are invoked by the graphics processing unit.

13. A non-transitory storage medium having stored thereon instructions that, when executed by at least one microprocessor of a computing device, cause the microprocessor to perform a method for controlling a digital visual interface (DVI) connection between a video graphics array (VGA) card and a display device of the computing device, the method comprising:
detecting a DVI resolution of the VGA card and a display resolution of the display device, the VGA card comprising a graphics processing unit, and a DVI connector connected to a signal switch through two DVI links;
determining whether the DVI resolution of the VGA card is greater than the display resolution of the display device;
controlling the graphics processing unit to turn on both of the two DVI links and controlling the signal switch to invoke a dual-link DVI mode of the VGA card, when the DVI resolution of the VGA card is greater than the display resolution of the display device; and
controlling the graphics processing unit to shut off one of the two DVI links and controlling the signal switch to change the dual-link DVI mode of the VGA card to a single link DVI mode of the VGA card, when the DVI resolution of the VGA card is not greater than the display resolution of the display device.

14. The storage medium according to claim 13, wherein the method further comprises:
acquiring DVI signals from a signal output port of the VGA card;
determining whether one of the DVI links fails to function; and
controlling the graphics processing unit to shut off the malfunction DVI link and controlling the signal switch to change the dual-link DVI mode of the VGA card to the single link DVI mode of the VGA card, when one of the DVI links fails to function.

15. The storage medium according to claim 13, wherein the method further comprises:
detecting a DVI working mode of the VGA card;
determining whether the DVI working mode of the VGA card is the dual-link DVI mode;
detecting a current display mode of the display device when the DVI working mode of the VGA card is the dual-link DVI mode;
determining whether the current display mode of the display device is an energy saving mode; and
controlling the graphics processing unit to shut off one of the two DVI links and controlling the signal switch to change the dual-link DVI mode of the VGA card to the single link DVI mode of the VGA card, when the current display mode of the display device is the energy saving mode.

16. The storage medium according to claim 13, wherein each of the DVI links comprises a data cable line that transfers video signals from the VGA card, and a clock signal line that controls frequency of the video signals.

17. The storage medium according to claim 13, wherein the VGA card runs in the single-link DVI mode when one of the DVI links is invoked by the graphics processing unit.

18. The storage medium according to claim 13, wherein the VGA card runs in the dual-link DVI mode when both of the two DVI links are invoked by the graphics processing unit.
